(19) United States
(12) Patent Application Publication
(10) Pub. No.: US 2013/0089240 A1
(43) Pub. Date: Apr. 11, 2013

(54) HANDHELD IRIS IMAGER

(71) Applicants: Malcolm J. Northcott, Felton, CA (US); J. Elon Graves, Los Gatos, CA (US); Howard Dando, Rio Del Mar, CA (US)

(72) Inventors: Malcolm J. Northcott, Felton, CA (US); J. Elon Graves, Los Gatos, CA (US); Howard Dando, Rio Del Mar, CA (US)

(73) Assignee: AOPTIX TECHNOLOGIES, INC., Campbell, CA (US)

(21) Appl. No.: 13/453,151

(22) Filed: Apr. 23, 2012

Related U.S. Application Data
(63) Continuation-in-part of application No. 13/268,906, filed on Oct. 7, 2011.

(51) Int. Cl. G06K 9/00; H04N 7/18

(52) U.S. Cl. 382/117; 348/78; 348/E07.085

(57) ABSTRACT

A portable, hand held iris imaging system captures iris images that may be used in biometric identification. The system is constructed using two separate but coupled subsystems. A first subsystem augments the underlying functionality of the second subsystem. The first subsystem uses an iris camera to capture iris images. A tunable optical element positioned between the subject and the iris camera focuses light reflected from the subject's eye onto the iris camera. A controller coordinates the capture of the iris image with the second subsystem. The second subsystem captures face images of the subject, which are provided to a display through a computer. The user interface is overlaid over the face images to provide visual feedback regarding how the system can be properly repositioned to capture iris images. The system has a portable form factor so that it may be easily operated.

### CROSS REFERENCE TO RELATED APPLICATIONS

This application is a continuation-in-part of co-pending U.S. application Ser. No. 13/268,906, filed Oct. 7, 2011, the contents of which are incorporated by reference herein in their entirety.

### BACKGROUND OF THE INVENTION

1. Field of the Invention

This application relates generally to portable biometric identification systems, and more specifically relates to portable iris imaging systems.

2. Description of the Related Arts

Iris imaging has numerous advantages to other types of biometric identification. Whereas human faces naturally change with age and human fingerprints can be affected by manual labor, the human iris remains constant with age and is generally well protected from wear and tear. Iris imaging for biometric purposes is also advantageous because it can be performed quickly and does not require physical contact with the subject. These aspects are particularly important if the iris imaging is being performed in a hostile environment, such as a warzone, or on uncooperative subjects.

Existing iris imaging systems suffer from a number of problems, including difficulties that increase the amount of time required to capture an iris image of sufficient quality for biometric identification. Existing iris imaging systems over-rely on the operator of the system to identify the eye for iris image capture. Existing iris imaging systems also use a fixed focal length lens. Any time the iris imaging system is not placed at the correct distance, iris image quality suffers due to lack of focus, and as a result may need to be retaken. Both of these issues may be solved by taking more time to capture the iris image, however taking the extra time may increase the danger posed to the operator if they working in a hostile environment.

Existing iris imaging systems are also problematic in that they are only operable in very close proximity to the subject. Requiring close proximity to the subject makes the iris imaging system more intrusive and difficult to use. In dangerous situations, this amplifies the potential dangers associated with capturing the iris image, particularly if the subject is at risk of causing the operator personal harm.

Existing iris imaging systems also suffer from problems associated with contamination of iris images by reflections of ambient light from the environment. The surface of the eye is roughly spherical with a reflectivity of a few percent, and as a result it acts like a wide angle lens. The surrounding environment is thus reflected by the surface of the eye, producing a reflected image which overlies the iris image. This reflected image can significantly degrade the accuracy of an iris image. Existing iris imaging systems have attempted to solve this problem by limiting the capture of images to indoor areas, by using a shroud to block out light from the environment, and/or by decreasing the distance between the system and the subject. These solutions decrease the ease of use of the iris imaging system. In hostile environments, both solutions negatively affect the safety of the operator.

Recent advances in iris imaging technology have enabled some iris imaging systems to be built in a portable form factor. However, existing portable iris imaging systems have drawbacks that decrease their effectiveness, particularly in hostile environments. Existing portable iris imaging systems are bulky, and as a result require the full attention of the operator, as well as both of the operator's hands, in order to function. In hostile environments, this compromises the safety of the operator.

### SUMMARY OF THE INVENTION

The present invention overcomes the limitations of the prior art by providing a portable, handheld iris imaging system that is operable in all light conditions and at long standoff distances. The system is easy and quick to operate, even in dangerous environments. The system is operable with only a single hand, increasing ease of use and freeing the operator's other hand for other tasks.

The iris imaging system is constructed using two different subsystems that are coupled together, directly or indirectly. The first subsystem allows for iris image capture, and comprises an iris camera, a filter, an illumination source, and a tunable optical element. The second subsystem comprises a face camera, a display, and a computer. The second subsystem may be, for example, a smartphone or another similar device.

Together, the first and second subsystems work in conjunction to capture iris images. The system as a whole may be positioned towards the subject to be captured using manual operator input or using an automated system including a steering assembly. In the manual case, a user interface is presented to the operator using the display, where the user interface overlays guide points over an image feed of the field of view of the system as captured by the face camera. The guide points assist the operator in positioning the system for iris image capturing, decreasing the time and difficulty usually associated with obtaining iris images. Alternatively, the steering assembly may automatically steer the system and the images it captures towards the subject.

The tunable optical element, light source, and iris camera may be used to focus on the face on the subject, and to fine focus on the irises of the subject. Once focused, the iris camera is used to capture iris images of the subject. The system may also be configured to capture face images, which may also be used in biometric identification.

### BRIEF DESCRIPTION OF THE DRAWINGS

The teachings of the embodiments of the present invention can be readily understood by considering the following detailed description in conjunction with the accompanying drawings.

FIG. 1 illustrates a portable, handheld iris imaging system with an iris camera and a face camera, according to one embodiment.

FIG. 2 illustrates an example face image with overlaid user interface guide points that may be displayed on the display of the second subsystem, according to one embodiment.

FIG. 3 is a flowchart illustrating a process for capturing an iris image using a portable, handheld iris imaging system, according to one embodiment.

### DETAILED DESCRIPTION OF EMBODIMENTS

### General Overview and Benefits

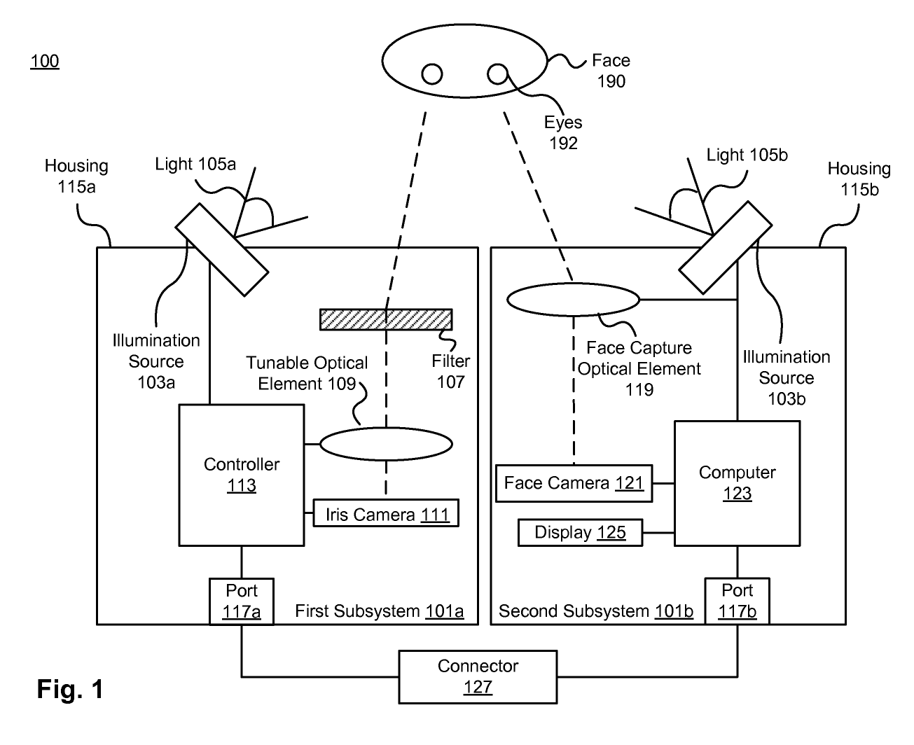

FIG. 1 illustrates a portable, handheld iris imaging system 100. The iris imaging system 100 is constructed using two separate but connected subsystems, each housed in its own housing 115. The first subsystem 101a is designed to augment the underlying functionality of the second subsystem 101b. For example, the first subsystem 101a may be an attachment that augments the functionality of a smartphone or a commercial digital camera, and the second subsystem 101b may be a smartphone or a commercial digital camera. The first subsystem 101a is configured to be electrically and physically coupled to the second subsystem 101b. The subsystems are physically coupled so that both subsystems may be repositioned together in unison, so that when iris images are captured the system 100 does not need to account for differences in the physical alignment between the two subsystems 101.

The first subsystem 101a captures images of irises. The first subsystem 101a comprises an illumination source 103a, a filter 107, a tunable optical element 109, an iris camera 111, a controller 113, and a port 117a, all within a housing 115a.

The illumination source 103a is located on an exposed face of the housing 115a of the first subsystem 101a. The illumination source 103a is capable of illuminating the subject's eyes 192 specifically, and may also be used to illuminate the subject's face 190 or the entirety of the subject. The illumination source 103a is configured to produce light at least in the infrared range, and may also be configured to produce light in the visible range. The illumination source 103a may be constructed using any light source that can produce the wavelengths at which the iris image will be captured. Examples include light emitting diodes, lasers, hot filament light sources, or chemical light sources.

In one implementation, the illumination source 103a is configured to emit light 105a within the wavelength range of 750 nanometers (nm) to 900 nm, inclusive. The illumination source 103a may also be configured to emit light having a wavelength within a few nanometers of a single wavelength, for example close to 750, 800, or 850 nm. The illumination source 103a may also be able to produce light of two or more different wavelengths or wavelength bands, for example light at or around 750 nm as well as light at or around 850 nm.

The illumination source 103a may be located on-axis with respect to the iris camera 111, such that the light 105a transmitted from the illumination source 103a travels a similar path to light reflected from the subject's eye 192. In this case, the illumination source 103a may also include waveguides for projecting the light 105a onto the axis of the reflected light. On-axis illumination puts glint reflections in the center of the pupil of the subject's eye 192 where they do not interfere with the iris image captured by the iris camera 11. Alternatively, the illumination source 103a may be located off-axis with respect to the iris camera 111. Off-axis illumination minimizes red-eye reflection from the pupil. There is a greater chance of glint reflections interfering with the iris signal the greater the angle used for off-axis illumination. In one embodiment, the illumination source 103a is located approximately 7 degrees off axis to reduce the intensity of red-eye reflection so that the pupil remains sufficiently dark to cleanly distinguish from the iris. The off-axis angle is not increased significantly above 7 degrees due to the increased risk of glint reflections. Off axis illumination works well when the subject is wearing glasses, due to reflections from the surface of the glasses being sufficiently displaced so as not to interfere with the image of the issi. images.

Band-pass filter 107 rejects light outside of a specified wavelength range and passes light within the specified range. For example, if the illumination source 103a emits light 105a at 750 nm, the band pass filter 107 may be designed to transmit light between 735-765 nm. In instances where the illumination source 103a emits light at multiple wavelengths, the filter 107 may be a dual band-pass filter which passes multiple ranges of wavelengths. For example, if the illumination source emits light at wavelengths of 750 and 850 nm, the filter 107 may be designed to pass light between the wavelengths of 735-765 nm and 835-865 nm. Filter 107 is positioned in the optical path of light reflected from the subject traveling into the iris camera 111. The filter 107 may be located between the subject and the tunable optical element 109 as shown iris camera 111 and the tunable optical element 109, or between the subject and the tunable optical element 109. The filter 107 increases the light level (or contrast) of the iris image relative to glint reflections of the environment from the cornea. The filter 107 also restricts the wavelength of light permitted to travel to the iris camera 111 so that the iris image is not contaminated by light from the visible region, where the morphology of the iris looks different than it does at the wavelengths of light emitted by the illumination source 103a.

The tunable optical element 109 is located in the optical path of the light reflected from the subject's eyes 192, in between the subject and the iris camera 111. The tunable optical element 109 may be located either between the filter 107 and the camera 111 as shown in FIG. 1, or between the subject and the filter 107 (not shown). The tunable optical element 109 focuses light reflected from the subject's eyes 192, specifically the subject's irises onto a plane located at the surface of the iris camera 111. By focusing the reflected light, the iris camera 111 is better able to capture iris images usable for biometric identification. The tunable optical element 109 may, for example, be a liquid lens or a micromechanically actuated fixed focus lens.

The iris camera 111 captures iris images by receiving light 105a from the illumination source 103a that has been reflected from the subject's eyes 192. In order to capture iris images with sufficient resolution for use in biometric identification, a light-sensitive sensor of the iris camera 111 should have at least 140 resolution elements across each iris (e.g., 7.3 pixels/mm for a 2 cm diameter iris). This may be met, for example, by having at least 140 pixels present in the diameter of each iris. The sensor of the iris camera 111 may, for example, be constructed using a CMOS image sensor. In one example, the CMOS image sensor is capable of capturing at least 5 megapixels (5,000,000 pixels) in each image. In another example, the CMOS image sensor is capable of capturing 9 or 18 megapixels in a single image. The camera may include other types of sensors, for example a charge coupled device (CCD). In one implementation, the iris camera 111 is configured to capture images within the infrared wavelength range of 750 nanometers (nm) to 900 nm, inclusive.

The iris camera 111 may also be able to receive light of two different wavelengths or wavelength bands, for example light at or around 750 nm as well as light at or around 850 nm. In some subjects, reflected light of shorter wavelengths can enhance the scalera boundary that defines the boundary between iris tissue and the white of the eye. By receiving light at multiple wavelengths, the iris camera 111 can improve the segmentation process used in determining the boundary of the iris, while simultaneously capturing an image of the iris at 850 nm. This improves, from a biometric perspective, the usefulness of the iris image. Iris images captured by the iris camera 111 are transmitted to the controller 113. The use of two wavelengths or wavelength ranges, however, can make it more difficult to filter out background glints relative to an implementation using only a single wavelength or wavelength range.

The controller 113 controls the operation of the first subsystem 101a. The controller 113 controls the operation of the illumination source 103a, the tunable active element 109, and the iris camera 111 to capture iris images. Iris images captured by the iris camera 111 are transmitted to the controller 113. The controller 113 may also control a steering assembly (not shown) that repositions the system 100 towards the subject without the need for operator input. The controller 113 is also configured to communicate data with the second subsystem 101b. The data may include, for example, iris images, messages related to iris image capture process, and instructions for repositioning the system 100 to assist in capturing iris images.

The port 117a of the first subsystem 101a forms a part of the electrical connection between the subsystems 101. The port 117a is configured to transmit data to and receive data from the second subsystem 101b.

In some implementations, the first subsystem 101a is augmented to include a steering assembly (not shown) to assist in automatically repositioning the system 100 towards the subject for iris image capture. The steering assembly may be physically mounted to a wall or other fixed structure. Alternatively, the steering assembly may be integrated into a handheld version of system 100 to speed up iris image acquisition, or to stabilize the image using feedback. In implementations using a steering assembly, the controller 113 uses a face finding algorithm to detect the subject's face 190 in images captured by the first 101a or second 101b subsystem. If no face is present in the captured images, the face finding algorithm may be further configured to locate the subject generally within the captured field of view. Based on the results generated by the face finding algorithm, instructions may be generated and sent to the steering system to automatically reposition the system 100 towards the subject's face 190, and/or towards the subject generally.

The steering assembly may also be configured to continue steering during image capture in order to compensate for system 100, or subject motion. This allows for longer exposures, and may potentially reduce image distortion in captured iris images.

In one embodiment, the steering assembly includes an adaptive optics assembly that uses tip-tilt measurements of incoming wavefronts of light to detect the position of the subject and adjust the position of the system 100 accordingly. For example, an illumination source 103 may emit light 105 that is then reflected from the subject. The reflected light is received by the adaptive optics assembly to determine the position and/or focus of the subject relative to the system 100. Based on the position of the subject, the adaptive optics assembly may activate one or more motors, thereby repositioning the system 100. As the system 100 moves, the adaptive optics assembly may continue to receive incoming wavefronts of light indicating the position of the subject. The adaptive optics assembly may include a negative feedback loop configured to discontinue motion of the system 100 once the system 100 has been sufficiently repositioned to capture iris images.

The system may also include other types of steering assemblies. For example, the system 100 may include a range finder for determining the position of the subject. The range finder may, for example, be a light based range finder or an ultrasonic sensor. The location of the subject may also be determined using stereo imaging and/or structured light. The steering assembly may also incorporate one or more positional or rotational motion sensors. In another embodiment, the steering assembly steers the system 100 so that the subject is in line of sight using one or more mirrors (not shown).

The second subsystem 101b is configured to capture face images and assist in positioning the system to capture iris images. In one embodiment, the second subsystem 101b comprises an illumination source 103b, a face capture optical element 119, a face camera 121, a computer 123, a display 125, and a port 117b, all within a housing 115b.

The illumination source 103b illuminates the subject so that the second subsystem 101b can capture a face image of the subject. Alternatively, the subject may be illuminated by illumination source 103a of the first subsystem for this purpose, in which case, the illumination source 103b may not be present.

The face capture optical element 119 focuses light reflected from the subject onto the face camera 121. The face capture optical element 119 is built depending upon the specifications of the face camera. Specifically, the face capture optical element needs to be able to focus sufficiently to make use of the pixels in the face camera 121.

The face camera 121 captures images of the subject, including the subject's face 190 from the light reflected from the subject through the face capture optical element 119. Images captured by the face camera 121 are used to assist the system 100 in focusing on the subject's eyes 192 for iris image capture. Face images particularly may also be used as biometric identifiers. Depending upon the implementation, face images captured by the face camera 121 consist of at least 90, 120, or 180 resolution elements between the subject's eyes 192 in order to have sufficient resolution for use as a biometric identifier.

The face camera 121 covers at least the intended capture area for iris image. The face camera 121 may be relatively low resolution (e.g. VGA, color or monochrome) compared to the iris camera 111. If biometric quality face images are required a higher resolution color camera may be used for the face camera 121. In this case, the face camera 121 may consist of two separate cameras a VGA camera for face finding, and a higher resolution for biometric face image capture. In this case, a wide angle lens may be used for the face finding camera (e.g., 3 mm focal length with a ⅓ inch sensor), and a longer focal length lens may be used for the biometric face image camera (e.g., a 8 mm focal length lens with a ⅓ inch sensor). In this case, the biometric face image camera may not need to have significantly more pixels than the face finder camera, since it will have a higher magnification lens.

In one embodiment, if a single camera is used for the face camera 121, it may have significantly higher resolution than the face finding camera described above (e.g., 5, 8, or 10 megapixels or more). In this case, the face camera 121 may be fitted with a wide angle lens (e.g., 3 mm) in order to cover the capture volume. During acquisition and face finding, the detector (not shown) within the face camera 121 would be operated at low resolution using binning and/or subsampling to downsize the image. This increase the rate at which frames may be captured, and allows for faster video processing. To capture biometric face images, the detector would be operated at high resolution.

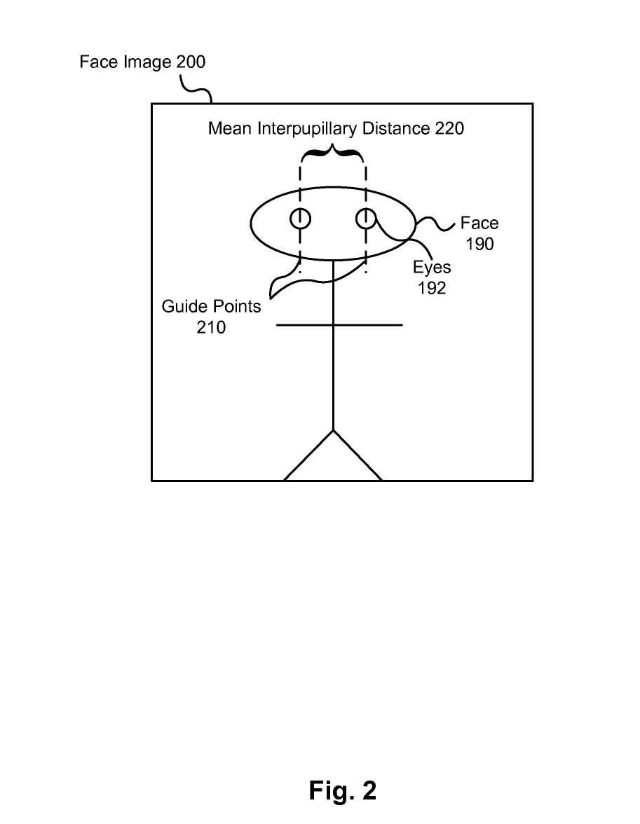

The computer 123 controls the operation of the second subsystem 101b. The computer 123 controls the operation of the illumination source 103a or 103b, the face capture optical element 119, and the face camera 121 to assist in repositioning the system 100 for iris image capture. Images captured by the face camera 111 are transmitted to the computer 123. The computer 123 is configured to overlay a user interface over the received face images, and provide the face images with overlaid user interface to the display 140. The user interface overlaid over received face images is further described with respect to FIG. 2 below. The computer 123 is also configured to communicate data with the controller 113. The data may include, for example, face images and messages related to iris image capture process.

The display 125 displays a user interface overlaying face images received from the face camera 121, to assist the operator in manually positioning the system 100 for image capture. The display 125 may also be configured to display captured iris images, captured face images, as well as the results of a biometric identification or authentication.

The port 117b of the second subsystem 101b forms another part of the electrical connection between the subsystems 101. The port 117b is also configured to transmit data to and receive data from the first subsystem 101b. In one embodiments, the ports 117 are directly connected to each other. In another embodiment, a connector 127 may be used to couple the ports 117 of the first 101a and second 101b subsystems.

In embodiments similar to the embodiment depicted in FIG. 1, the presence of both the controller 113 and computer 123 may alleviate any performance bottleneck due to the limitations of the second subsystem 101b. For example, if the second subsystem 101b only allows a limited amount of data traffic to be transmitted or received, offloading functionality to the controller 113 may alleviate the need to transfer some data traffic between the first 101a and second 101b subsystems. In other embodiments, either one of the controller 113 or the computer 123 may not be present, as all functions performed by one may instead be performed by the other. In this case, the other components of each subsystem 101 may be electrically coupled to port 117 so that they may be remotely controlled by the controller 113 or computer 123 of the other subsystem 101.

In other embodiments, in addition to iris images and face images, system 100 may also be configured to capture other types of biometric identifiers. For example, system 100 may be augmented with a fingerprint reader (not shown) to allow for capture of fingerprint biometric identifiers, and a voice capture system (not shown) to allow for capture of voice biometric identifiers. Other non-conventional biometrics may also be captured, including video based biometrics that use accelerometer measurements from a touch screen as biometric identifiers. Any combination of biometric identifiers (e.g., iris, face, finger) for a single subject may be combined into a biometric file. Optionally, the biometric file may be cryptographically signed to guarantee that the individual biometric identifiers that make up the biometric file cannot be changed in the future.

The system 100, including both the first 101a and second 101b subsystems, can be operated with one hand. In one example, the iris imaging system weighs less than 5 pounds. In another example, the iris imaging system weighs less than 3pounds. In one embodiment, system 100 may also include physical restraints that are placed in contact with the subject to ensure they are properly positioned for iris image capture.

FIG. 2 illustrates an example face image 200 with overlaid user interface guide points 210 that may be displayed on the display 125 of the second subsystem 101b, according to one embodiment. Displaying a face image 200 with overlaid user interface guide points 210 provides the operator with information about whether a subject's face is within the field of view, and whether the subject is at an acceptable standoff distance for iris image capture. This information may, for example, assist the user in manually repositioning the system 100 towards the subject.

The guide points 210 of the user interface are illustrative of how the system 100 may be correctly positioned in order to capture iris images. The guide points 210 may, for example, include one or more hash marks, boxes, circles, or other visual indications that align with the subject's eyes 192 and/or face 190. When the guide points 210 are aligned with the subject's eyes 192 and/or face 190, the subject is at least approximately at an acceptable standoff distance for iris image capture by the system 100. In one embodiment, the guide points 210 are placed on the user interface at a fixed position such that they map to the mean inter-pupillary distance 220 of the human population at a standoff distance that is acceptable for iris image capture for a large majority of the entire human population. Placing the guide points so that most possible subjects can be captured over a wide range of standoff distances facilitates the ease of use of the system 100.

For example, if the first subsystem is a iPhone™ smartphone, the guide points 210 may be placed at 1 millimeter (mm) separation in the image space (i.e., in the plane of the display 125 or the sensor of the face camera 121), where the sensor of the face camera 121 has a paraxial magnification of approximately 60× at a standoff distance of 27.5 cm. Although the 60× paraxial magnification is between the user and the sensor, there may be additional magnification of the image that occurs between the sensor and graphic user interface displayed on the display 125. This additional magnification may be on the order of 10-15×. Thus, 1 millimeter (mm) on the sensor may correspond to 10-15 mm on the GUI display. By positioning the guide points 210 with this separation, the system 100 is able to capture iris images for at least 85% of the human population within a standoff distance range of 17.5-50 cm, preferably 25-35 cm. The system may also be able to capture iris images where the standoff distance is less than or equal to 17.5 cm.

The user interface may also include visual indications (not shown) of the progress of a subject location algorithm running on the computer 123. The subject location algorithm receives images from the face camera 121 and processes them to determine the positioning of the system 100. Responsive to this, the subject location algorithm provides the user interface with visual progress indications. The visual indications may include a reward indicator (for example a green dot or outline around the subject) that is displayed with the subject is within the field of view of the face camera 121, which differs from another visual indicator (for example a yellow dot or arrows pointing towards a subject) which indicates that a subject has not yet been found within the field of view of the face camera 121. In one embodiment, the system 100 uses audio and/or haptic feedback (not shown) in the user interface. These types of feedback provide alternatives to the visual indications mentioned above in cases where either display 125 visibility is compromised (e.g., due to bright sunlight) or where the user is visually disabled.

The visual indications may also include boxes (not shown) indicating whether the subject is located at an acceptable standoff distance from the system 100 for iris image capture. The boxes around the subject's eyes 192 may be configured to change colors, to provide feedback regarding whether the subject is within the correct standoff distance range for iris image capture. For example, red may indicate that the subject is too close to the system 100, white may indicate that the subject is too far from the system 100, and green may indicate that the subject is within the correct standoff distance range for iris image capture. In other implementations, the system 100 may include speakers (not shown) to provide audible indicators that supplement or replace the visual indicators.

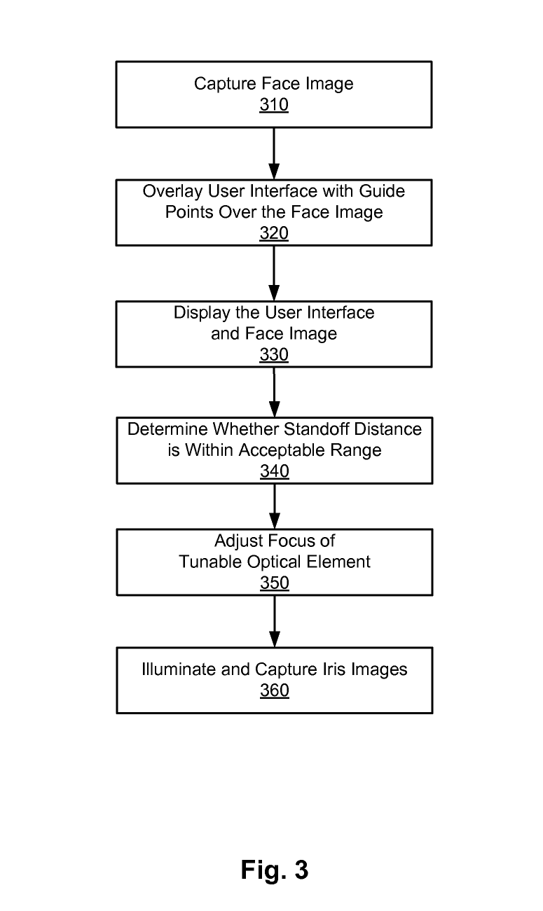

FIG. 3 is a flowchart illustrating a process for capturing an iris image using a portable, handheld iris imaging system, according to one embodiment. To capture iris images, the system 100 provides mechanisms for facilitating the positioning of the system 100 with respect to the user. In the example embodiment of FIG. 3, positioning of the system 100 towards the subject is performed manually by the operator. Positioning may also be performed automatically (not shown).

To assist the operator in manually positioning the system 100 towards the subject, the face camera 121 captures 310 face images and provides them to the computer 123. The computer overlays 320 a user interface over the received images, and provides the images to the display 125. The images and overlay are displayed 330 to the operator, providing the operator with visual feedback regarding the position of the system 100 relative to the subject.

With respect to steps 310, 320, and 330, the visual feedback informs the operator when the subject's face is in the field of view of the face camera 121. The visual feedback is used by the operator to assist in manually positioning the system 100. The operator may manually position the system 100 towards the subject by holding the system 100 in one or two hands, and moving their hand/s with respect to the subject.

To automatically position the system 100 towards the subject (not shown), the system 100 is augmented to include a steering assembly (not shown). As described above, a face finding algorithm processes images captured by either the first 101a or second 101b subsystem to determine the location of the subject. Based on the results of the face finding algorithm, instructions are provided to the steering assembly to automatically reposition the system 100.

The system 100 determines 340 whether the subject is within an acceptable standoff distance range from the subject for iris image capture. The standoff distance may be determined in several different ways. In one embodiment, the standoff distance can be determined based on the alignment of the guide points of the user interface with the captured face image. If the guide points and the subject are sufficiently aligned, the standoff distance may be approximated based on the alignment. In one embodiment, the alignment provides a rough measurement of the eye separation or face size of the subject, which in turn is used to determine a rough approximation of the standoff distance.

In another embodiment, a range finder (not shown) may be used to determine the standoff distance. The range finder may communicate the determined standoff distance to the system 100. In another embodiment, the face finding algorithm may be configured to determine the standoff distance. The face finding algorithm may make the determination based on processing captured images. The face finding algorithm may also make use of the steering assembly to determine the standoff distance.

In another embodiment, the standoff distance is determined by adjusting the tunable optical element 109 as light reflected from the subject's eyes 192 passes through the tunable optical element to the iris camera 111. The tunable optical element 109 has a transfer function where a measurable stimulus (e.g., a voltage in the case of a liquid lens) changes in response to a received optical power. An autofocus algorithm running on the controller 113 can be used to determine a measurable stimulus for a number of different tunings of the tunable optical element 109. In one embodiment, the measurable stimulus with the highest received optical power indicates the point at which the subject is in focus according to the optical element 109. This focus can be converted to determine a standoff distance.

The correlation between standoff distance and measurable stimulus may also depend upon the physical parameters of the iris camera 111. These parameters may include, for example, the optical properties of the lenses of the iris camera 111, the properties of the image sensor contained within the iris camera 111 such as the transfer function of the sensor. The determined standoff distance may also be refined based on the details of the images captured by the iris image including the sharpness, edges, and resolution of specular reflections from the eyes 192 of the subject.

More generally, the standoff distance may be determined using a merit function. The merit function uses an image processing procedure (e.g., the standoff distance to measurable stimulus process described above) to return a merit value. The merit value is, over the region of interest, monotonically related to the quality of focus of the iris image. The tunable optical element 109 is then adjusted to minimize or maximize the merit value depending on the sign of the merit function. In addition to the standoff distance/measurable stimulus example above, another example of a merit function is based on the peak intensity of the glint image brightness.

In one embodiment, the determination 340 of whether the standoff distance is within an acceptable range is performed only once, using any of the techniques described above. In another embodiment, standoff distance determination 340 is multi-stage process, where each stage of the process determines the standoff distance with increasing accuracy. For example, guide point alignment with face images captured by the face camera 121 may be used as a coarse pass approximation for whether the standoff distance is within an acceptable range. Subsequently, tunable optical element 109 used to more precisely determine the standoff distance. At each stage in the multi-stage process, it may be determined that the standoff distance is not acceptable and that repositioning of the system 100 is needed to allow iris image capture.

The determination 340 of the standoff distance may indicate that despite earlier positioning efforts, the system 100 still needs to be repositioned. This may occur, for example, if after earlier positioning, the system 100 was on the border of the acceptable range of standoff distances. As described above, the system 100 may be positioned either manually or automatically to fall within the acceptable range of standoff distances.

If the subject is an acceptable standoff distance from the system 100 the system 100 focuses 350 on the subject's eyes, specifically the irises, for iris image capture by iris camera 111. In one embodiment, for focus 350 the illumination source glint may be used to determine focus 350. The illumination source 103a may need to be run at comparatively low power compared to the power level used to capture iris images in order to ensure that the glint is not saturated. In one embodiment, the tunable optical element 109 is adjusted 350 using a dithering technique. The standoff distance may also be used to adjust the focus 350 of the tunable optical element 109.

Images captured by the iris camera are processed by the controller 113 to determine an image focus metric. Using the image focus metric, the controller 113 determines when sufficient focus has been achieved. Provided the captured iris images are sufficiently well sampled and the lens is of sufficiently high quality, an absolute focus error, in some cases with ambiguous sign, can be determined by examining the lens point spread function. The point spread function may be measured from the glint image, provided the glint image is not saturated. In determining the focus metric, the signal to noise ratio, processing time, knowledge of the morphology of the iris, and other factors may be taken into account. In our embodiment, a set of images is collected spanning the possible focusing range of the tunable optical element. A focus metric is determined for each image. The focus 350 is determining using a peak-finding algorithm.

The system 100 may focus on one iris at a time, or both simultaneously. Adjusting the focus individually for each eye improves the quality of each iris image. This can be advantageous if the subject is not directly facing the system 100, or if the system 100 is not being held normal to the line of sight to the subject. To focus 350, the subject may be illuminated with either illumination source 103a or 103b. Similarly to the determination of standoff distance, the focus 350 may be determined in a single pass, or iteratively over multiple passes. In between each pass, the system may be repositioned and the standoff distance may be re-determined.

In one embodiment, if the illumination source 103b is used during focus 350, the focus 350 of the tunable optical element 109 is offset to allow for chromatic aberration between the wavelength of light 105a used for focusing, and the wavelength of light 105a used for iris imaging. This helps improve the focus of the captured iris images. Alternatively, chromatic aberration may be avoided by focusing 350 the tunable optical element 109 while illuminating the iris at low power with the illumination source 103a, instead.

Generally, the focusing 350 of the tunable optical element 109 on the subject's irises is accomplished as quickly as possible so that iris images may be captured before the subject moves. Focus 350 is accomplished more quickly than initial positioning, for example. Focus 350 is accomplished quickly by shortening the sensor integration time of the sensor of the iris camera 111. Additionally, during focusing 350 the subject's eyes may be illuminated by the illumination source 103a with additional light to overcome the influence of non-light source signals (e.g., background signals) on images captured by the iris camera 111.

To capture 360 iris images, the controller 113 controls the operation of the illumination source 103a and iris camera 111 to synchronize the capture 360 of iris images with the illumination 360 of the subject's eyes 192. In order to remove contamination from ambient light and capture a high quality iris image, the controller 113 activates 360 the illumination source 103a at a very high intensity for a short amount of time and causes the iris camera 111 to capture 360 the iris image during that brief interval. Typically, the interval of the illumination is between 1 to 10 milliseconds (ms), inclusive. A high intensity illumination increases the amount of light 105 reflected from the iris, increasing the quality of the iris image by overwhelming any background light that has reflected from the cornea surface. The shorter the interval of illumination, the higher in intensity the illumination may be without causing damage to the subject's eyes 192 or exceeding eye safety limits.

As an alternative to illuminating 360 the subject's eyes 192 in a single pulse, the controller 113 may cause the illumination source to illuminate 360 the subject's eyes 192 multiple times within a short interval. For example, each of the several pulses may be approximately 1-2 ms in length, spaced over the course of 10-12 ms. In conjunction with the pulsed illumination 360, the iris camera's 111 capture 360 of iris images is synchronized with the pulsing in order to further prevent any background light from contaminating the iris images. An iris image may be captured during each pulse.

In one embodiment, iris image capture 360 may be performed using active background subtraction using 2 images captured 360 in quick succession. For example, a first image could be taken with a 5 ms exposure, with no illumination, and a second image taken with a 5 ms exposure and with flash illumination. Subtracting the first image from the second image removes environmental influences on the resulting iris image.

Pulsing illumination 360 also allows the illumination source 103a to achieve a higher power level (brightness or intensity) than may be obtained for longer illumination periods. For example, the intensity may be increased 5× for an exposure of 200 microseconds relative to steady state intensity, and 2× for exposure of 10 milliseconds. While still taking into account eye safety limits, the larger the amount of light 105a that can be reflected from the subject's eye 192, the higher the quality of the resulting iris image. Eye safety limits for exposure to light depend upon the wavelength of light used, the exposure time, and the angle subtended by the source.

As an additional benefit, if the first few pulses of light are in the visible wavelength range (e.g., using another illumination source such as illumination source 130b), the subject's eye is expected to react by contracting the iris dilator muscle, thereby increasing the visible surface of the iris that will be captured 360 during subsequent pulses 260. This improves the quality of the captured 360 iris images. Accommodation may be used to determine whether or not the iris being imaged is a real iris or a fake (spoofed) iris.

The system 100 may capture 360 an iris image for each eye 192, one eye at a time. Capturing one eye at a time improves the quality of each captured image. Alternatively, the system 100 may capture 360 iris images for both eyes 192 simultaneously. Capturing both eyes 192 simultaneously reduces the amount of time required to capture iris images for both eyes 192.

Upon capture 360 of the iris image, the controller 113 compares the captured iris image against a quality metric to determine if the iris image is sufficient for use in biometric identification. The quality metric may be based on a statistical correlation of various quality factors to the biometric performance of a database of images. The quality metric may also incorporate comparing the captured image to a database of images to determine whether the captured image is sufficient. The capture image may also be compared to a International Organization for Standardization (ISO) quality criterion for quality of focus or image sharpness. These ISO quality criterions may be incorporated into the quality metric. If the iris image meets the requirements of the quality metric, the display 125 optionally presents a visual indication that iris image capture was successful.

### Additional Considerations

Some portions of above description, for example with respect to the controller 113 and computer 123, describe the embodiments in terms of algorithms and symbolic representations of operations on information, or in terms of functions to be carried out by other components of the system, for example the optical elements, cameras, and display. These algorithmic descriptions and representations are commonly used by those skilled in the data processing arts to convey the substance of their work effectively to others skilled in the art. These operations, while described functionally, computationally, or logically, are understood to be implemented by computer programs executed by a processor, equivalent electrical circuits, microcode, or the like. The described operations may be embodied in software, firmware, hardware, or any combinations thereof.

In addition, the terms used to describe various quantities, data values, and computations are understood to be associated with the appropriate physical quantities and are merely convenient labels applied to these quantities. Unless specifically stated otherwise as apparent from the following discussion, it is appreciated that throughout the description, discussions utilizing terms such as “processing” or “determining” or the like, refer to the action and processes of a computer system, or similar electronic computing device, that manipulates and transforms data represented as physical (electronic) quantities within the computer system memories or registers or other such information storage, transmission or display devices.

The controller 113 and computer 123 may be specially constructed for the specified purposes, or it may comprise a general-purpose computer selectively activated or reconfigured by a stored computer program. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), field programmable gate arrays (FPGAs), or any type of media suitable for storing electronic instructions, and each coupled to a computer system bus. Furthermore, the controller 113 and computer 123 referred to in the specification may include a single processor or may be architectures employing multiple processor designs for increased computing capability.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A portable, hand held iris imaging system comprising:
a first subsystem configured to be electrically and physically coupled to a second subsystem, the first subsystem comprising:
an illumination source configured to illuminate a subject's eye;
an iris camera configured to capture an image of an iris of the illuminated subject's eye with sufficient resolution for biometric identification; and
a tunable optical element positioned between the illumination source and the iris camera, the tunable optical element comprising an adjustable focus capable of focusing light reflected from an iris of the subject onto the iris camera where the iris camera is located at a standoff distance in a range of 17.5 cm and 50 cm from the subject.

2. The system of claim 1 wherein the first subsystem comprises a controller configured to determine the standoff distance by adjusting the adjustable focus of the tunable optical element and measuring a stimulus of the tunable optical element.

3. The system of claim 1 wherein the first subsystem is configured to receive instructions for determining the standoff distance from the second subsystem and to send the determined standoff distance to the second subsystem.

4. The system of claim 1 comprising a steering assembly configured to adjust the position of the system based on a location of the subject.

5. The system of claim 4 wherein the steering assembly comprises an adaptive optics assembly configured to receive light reflected from the subject and to steer the system towards the subject based on the received light.

6. The system of claim 4 wherein the steering assembly comprises one or more mirrors configured to receive light reflected from the subject and to steer the system towards the subject based on the received light.

7. The system of claim 1 wherein the first subsystem comprises a housing containing the illumination source, the camera and the tunable optical element, the housing having a portable form factor able to be held by a single human hand.

8. The system of claim 1 wherein the illumination source produces light in a wavelength range of 750 nm to 900 nm, inclusive.

9. The system of claim 1 wherein the first subsystem comprises a band pass filter positioned between the subject and the iris camera, the filter configured to transmit a portion of the light reflected from the illuminated subject's eye towards the iris camera.

10. The system of claim 1 wherein the adjustable focus is further capable of focusing light reflected from an iris of the subject onto the iris camera where the iris camera is located at a standoff distance of less than or equal to 50 cm from the subject.

11. A portable, hand held iris imaging system comprising:
a second subsystem configured to be electrically and physically coupled to a first subsystem, the second subsystem comprising:
a face camera configured to capture an image of a face of a subject;
a display configured to display the face image and a user interface overlaying the face image, the user interface comprising one or more guide points indicating a position of the system able to capture an iris image of the subject; and
a computer configured to communicate data to the first subsystem, the data assisting in the capture of an iris image of the subject.

12. The system of claim 11 wherein the guide points comprise two guide points positioned approximately a mean interpupillary distance for a majority of a human population at a standoff distance.

13. The system of claim 12 wherein the standoff distance is in a range of 17.5 cm and 50 cm from the subject.

14. The system of claim 11 wherein the computer is configured such that when a subject's eyes are aligned with the guide points, the computer communicates with the first subsystem to capture the iris image.

15. The system of claim 11 wherein the computer is configured to receive the face image from the face camera and perform a face finding operation on the face image.

16. The system of claim 15 comprising a steering assembly configured to mount the system on a fixed surface and to adjust the position of the system based on the face finding operation.

17. The system of claim 11 wherein the second subsystem comprises a housing containing the face camera, the display, and the computer, the housing having a portable form factor able to be held by a single human hand.

18. The system of claim 11 wherein the user interface comprises a visual indication of whether the first subsystem is able to capture the iris image based on a current position of the first subsystem.

19. A method for capturing an iris image using a portable, hand held iris imaging system, comprising:
capturing with a face camera a face image of a subject standing a standoff distance away from the system;
overlaying over the face image a user interface comprising one or more guide points indicating a position of the system able to capture an iris image of the subject;
displaying the face image and the user interface on a display;
determining whether the standoff distance is within an acceptable range for iris image capture, the determination based on the alignment of the guide points and the face image;
responsive to the standoff distance being within the acceptable range, adjusting a focus of a tunable optical element to focus the subject's eyes;
illuminating the subject's eyes with an illumination source; and
capturing an iris image of the subject's eyes with sufficient resolution for biometric identification.

20. The method of claim 19 wherein the guide points comprise two guide points positioned approximately a mean interpupillary distance for a majority of a human population at a standoff distance.

21. The system of claim 19 wherein the acceptable standoff distance range is between 17.5 cm and 50 cm, inclusive, from the subject.
